(19) United States
(12) Patent Application Publication
(10) Pub. No.: US 2025/0129758 A1
(43) Pub. Date: Apr. 24, 2025

(54) ENGINE APPARATUS

(71) Applicant: Yanmar Holdings Co., Ltd., Osaka (JP)

(72) Inventors: Kazuteru TOSHINAGA, Osaka-shi (JP); Daichi MATSUNAGA, Osaka-shi (JP); Kenji HIRAOKA, Osaka-shi (JP); Yusuke HONDA, Osaka-shi (JP)

(73) Assignee: Yanmar Holdings Co., Ltd., Osaka (JP)

(21) Appl. No.: 18/920,439

(22) Filed: Oct. 18, 2024

(30) Foreign Application Priority Data
Oct. 20, 2023 (JP) 2023-181194

(51) Int. Cl. F02M 37/00

(52) U.S. Cl. CPC F02M 37/0052; F02M 2700/123; F02M 2700/4302

(57) ABSTRACT

The engine apparatus runs on fuel containing a corrosive substance and includes a blow-by returning injector that returns the blow-by gas to the combustion chamber of the engine. The corrosive substance contained in the fuel is ammonia or methanol.

### TECHNICAL FIELD

The present invention relates to an engine apparatus that is ran on fuel containing a corrosive substance.

### BACKGROUND ART

Conventionally, some engine apparatuses run on fuels containing corrosive substances such as ammonia and methanol. In the engine apparatus, the fuel gas supplied to a combustion chamber may leak into a crank chamber (crankcase) as blow-by gas. Therefore, it is required to treat such blow-by gas in the engine apparatus.

For example, Patent Document 1 discloses a blow-by gas returning device that includes: an air introducing passage used in an internal combustion engine having an intake passage in which a turbocharger and an intercooler for cooling intake gas pressurized by the turbocharger are provided and through which the intake gas in the intake passage flows into a crankcase of the internal combustion engines; and a gas recirculating passage through which blow-by gas in the crankcase of the internal combustion engine is recirculated into the intake passage. The gas recirculating passage communicates with the intake passage on the intake upstream side of the turbocharger, so that the blow-by gas in the crankcase is recirculated to the intake passage and flows into the combustion chamber again. The air introducing passage communicates with the intake passage on the intake downstream side of the turbocharger and on the intake upstream side of the intercooler, so that a portion of the air compressed by the turbocharger is supplied into the crankcase to ventilate the inside of the crankcase.

### PRIOR ART DOCUMENT

### Patent Document Patent Document 1: Japanese Patent No. 4383983

### SUMMARY OF INVENTION

### Technical Problem

In the case of an engine apparatus that runs on fuel containing a corrosive substance, as in the conventional technique such as Patent Document 1, since the toxic and corrosive fuel containing, for example, ammonia, flows into the upstream side of the intake passage in the intake direction, not only the intake passage but also the intake system components such as the turbocharger and the intercooler are contaminated (corroded), and there is a concern that the replacement interval (product life) of the intake system components is shortened. To avoid such risk, it is necessary to use a corrosion-resistant material for the intake system components or to apply a corrosion-resistant coating to the intake system components. However, in this case, there is a concern that the cost will increase and the marketability will decrease.

In the engine apparatus, by supplying the blow-by gas to a combustion chamber together with normal fuel, the blow-by gas is reused as fuel, and an effect of reducing the fuel consumption is expected. However, in the conventional technique, there is a risk that the fuel component of the blow-by gas blows through from an intake port to an exhaust port at the time of valve overlap of the combustion chamber and flows out to the exhaust side without being burned in the combustion chamber. In such a case, the blow-by gas mixies into the exhaust gas, and causes deterioration of the exhaust gas component and a reduction in the effect of reducing fuel consumption.

An object of the present invention is to provide an engine apparatus capable of suppressing contamination of intake system components due to return of the blow-by gas to a combustion chamber, suppressing the cost of the intake system components, and prolonging the product life of the intake system components.

### Solution to Problem

In order to solve the above problem, an engine apparatus of the present invention is an engine apparatus that is ran on fuel containing a corrosive substance, and includes a blow-by returning injector or a blow-by returning mixer that returns blow-by gas to a combustion chamber of the engine.

### Advantageous Effects of Invention

The present invention provides an engine apparatus capable of suppressing contamination of intake system components due to return of the blow-by gas to a combustion chamber, suppressing the cost of the intake system components, and prolonging the product life of the intake system components.

### BRIEF DESCRIPTION OF DRAWINGS

FIG. 1 is a schematic diagram illustrating an example of an engine apparatus according to an embodiment of the present invention.

FIG. 2 is a schematic diagram illustrating an example of an engine cylinder of an engine apparatus according to an embodiment of the present invention.

FIG. 3 is a schematic diagram illustrating an example of an engine apparatus according to a first modification of the present invention.

FIG. 4 is a schematic diagram illustrating an example of an engine apparatus according to a second modification of the present invention.

FIG. 5 is a schematic diagram illustrating an example of an engine apparatus according to a third modification of the present invention.

FIG. 6 is a schematic diagram illustrating an example of an engine cylinder of an engine apparatus according to the third modification of the present invention.

FIG. 7 is a schematic diagram illustrating an example of an engine cylinder of an engine apparatus according to the third modification of the present invention.

FIG. 8 is a schematic diagram illustrating an example of an engine apparatus according to a fourth modification of the present invention.

### DESCRIPTION OF EMBODIMENTS

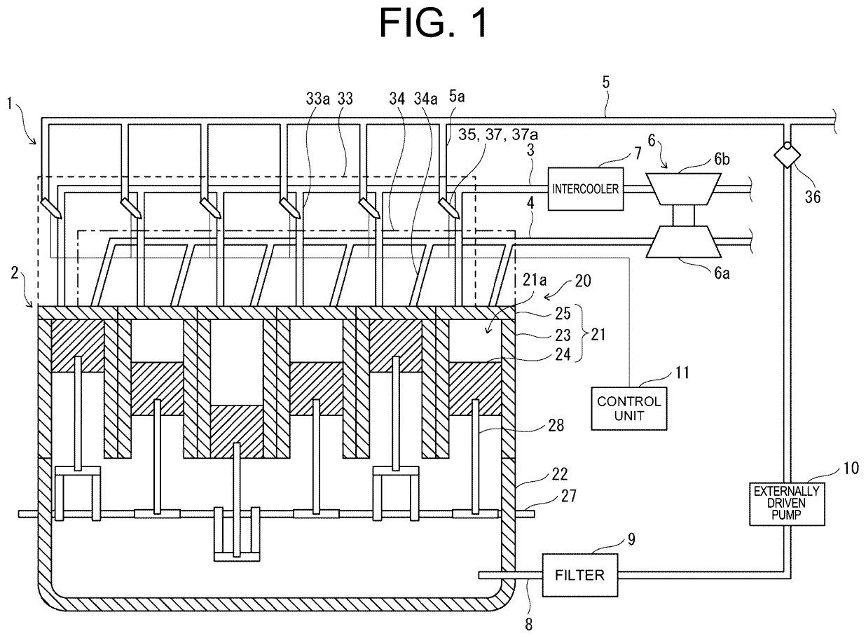

An engine apparatus 1 according to an embodiment of the present invention will be described with reference to drawings. As illustrated in FIG. 1, the engine apparatus 1 includes an engine 2, an intake passage 3, an exhaust passage 4, a fuel supply path 5, a turbocharger 6, and an intercooler 7. The engine apparatus 1 further includes a blow-by path 8, a filter 9, an externally driven pump 10, and a control unit 11.

In the present embodiment, in particular, the engine apparatus 1 is a gas engine that run introducing fuel (fuel gas) such as gaseous fuel containing toxic and corrosive substances such as ammonia and methanol into a combustion chamber 21a of the engine 2. The fuel is supplied to the combustion chamber 21a as a mixture with air.

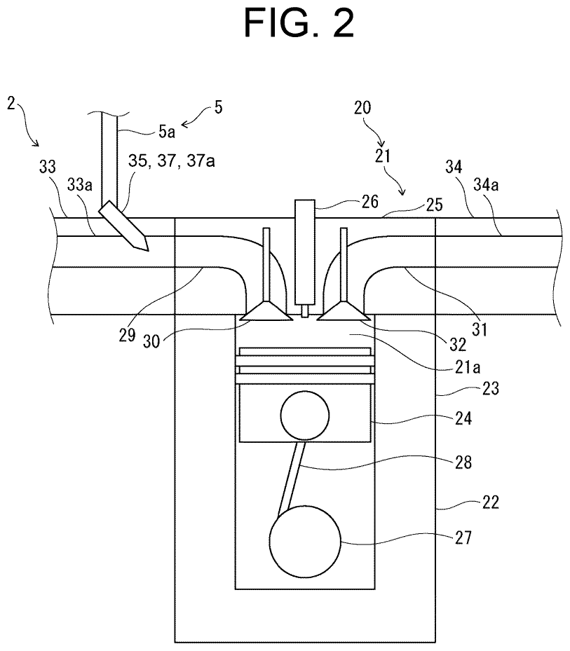

The engine 2 is, for example, a four-stroke engine, and includes a plurality of cylinders 21, and a crankcase 22 in a cylinder block 20. Although six cylinders 21 are illustrated in FIG. 1, the number of cylinders 21 is not limited to six. As illustrated in FIGS. 1 and 2, each of the cylinders 21 includes a cylinder portion 23, a piston 24, and a cylinder head 25.

The cylinder portion 23, for example, is formed to have a cylindrical shape in the cylinder block 20, and the piston 24 is slidably housed in the cylinder portion 23. The cylinder head 25 is attached to the upper side of the cylinder portion 23, and defines a combustion chamber 21a on the inner sides of the cylinder portion 23 and the cylinder head 25. The cylinder head 25 is provided with an ignition device 26 for igniting the fuel in the combustion chamber 21a. The ignition device 26 may comprise a micro pilot type device that injects a small amount of liquid fuel, or may comprise a spark ignition type device that uses an ignition plug. Alternatively, it may have a configuration in which a mixture of a gas fuel and a liquid fuel is compression-ignited.

Each cylinder portion 23 of each of the cylinders 21 communicates with the crankcase 22, and a crankshaft 27 is rotatably supported by the crankcase 22. The piston 24 of each cylinder 21 is connected to the crankshaft 27 via a connecting rod 28, and a reciprocating motion of the piston 24 is converted into a rotational motion of the crankshaft 27 via the connecting rod 28.

The cylinder head 25 has an intake port 29 that communicate with the combustion chamber 21a and an intake valve 30 that open and close the intake port 29. The combustion chamber 21a is connected to the intake passage 3 via the intake port 29 or the like, and air or a mixture of air and fuel supplied from the intake passage 3 is introduced into the combustion chamber 21a. The cylinder head 25 has an exhaust port 31 communicating with the combustion chamber 21a and an exhaust valve 32 for opening and closing the exhaust port 31. The combustion chamber 21a is connected to the exhaust passage 4 via the exhaust port 31 and the like, and exhaust gas generated in the combustion chamber 21a is discharged to the exhaust passage 4.

In order to connect the intake passage 3 and the plurality of cylinders 21, an intake manifold 33 having a branched intake flow path 33a branching from the intake passage 3 to each intake port 29 of the plurality of cylinders 21 is provided between the intake passage 3 and the engine 2. In order to connect the exhaust passage 4 and the plurality of cylinders 21, an exhaust manifold 34 having a branched exhaust passage 34a branching from the exhaust passage 4 to the plurality of cylinders 21 is provided between the exhaust passage 4 and the engine 2. In FIG. 1, the intake manifold 33 is indicated by a broken line, and the exhaust manifold 34 is indicated by a one-dot-chain line.

The intake passage 3 is connected to the plurality of cylinders 21 of the engine 2 and supplies compressed and cooled air to each of the cylinders 21. A mixture of air supplied from the intake passage 3 and fuel supplied from a fuel tank (not illustrated) through the fuel supply path 5 is supplied to the combustion chamber 21a of each of the cylinders 21. In the intake passage 3, the turbocharger 6 that compresses the air or the mixture of fuel and air flowing through the intake passage 3 and sends the compressed air or mixture to the downstream side in the intake direction is provided on the upstream side in the intake direction, and the intercooler 7 that cools the air flowing through the intake passage 3 is provided on the downstream side in the intake direction of the turbocharger 6. The intake passage 3 may be provided with an air filter (not illustrated) that purifies fresh air and introduces the purified fresh air into the intake passage 3.

The exhaust passage 4 is connected to the plurality of cylinders 21 of the engine 2, and allows the exhaust gas generated in each cylinder 21 to flow therethrough and be discharged.

The fuel supply path 5 supplies fuel supplied from a fuel tank (not illustrated) to the engine 2. For example, the fuel supply path 5 has a plurality of branched fuel paths 5a branched to feed fuel toward each of the cylinders 21, and the branched fuel paths 5a are connected to the terminal end of the branched intake flow path 33a of the intake manifold 33 provided for each of the cylinders 21.

The fuel supply path 5 is provided with a main fuel supply device 35 for feeding the fuel fed through the fuel supply path 5 to the combustion chamber 21a of each of the cylinders 21. The main fuel supply device 35 includes, for example, a gas admission valve and a gas injector. For example, in order to supply fuel to each of the plurality of cylinders 21, the plurality of main fuel supply devices 35 are provided at the terminal ends of the corresponding branched fuel paths 5a, and inject fuel at the terminal ends of the branched intake flow paths 33a of the intake manifolds 33 for the cylinders 21.

When fuel is supplied to each of the cylinders 21, the main fuel supply devices 35 are controlled by the control unit 11 to inject fuel, and intermittently injects fuel so as to supply fuel to the combustion chamber 21a at a timing at which the exhaust port 31 is closed and the intake port 29 is opened so that the blow-by of the fuel due to the valve overlap of the combustion chamber 21a does not occur.

The turbocharger 6 compresses the air or air-fuel mixture flowing through the intake passage 3 and sends the compressed air or air-fuel mixture to the downstream side in the intake direction. The turbocharger 6 includes a turbine 6a and a compressor 6b. The turbine 6a is arranged in the exhaust passage 4, and the compressor 6b is arranged in the intake passage 3. The turbine 6a is rotated by exhaust gas flowing through the exhaust passage 4, and the compressor 6b is driven by the rotational force of the turbine 6a, whereby air or air-fuel mixture flowing through the intake passage 3 is compressed.

The blow-by path 8 is connected from the crankcase 22 to the fuel supply path 5. When fuel gas leaks from the combustion chamber 21a of each of the cylinders 21 to the crankcase 22, blow-by gas is generated in the crankcase 22. However, the blow-by gas flows through the blow-by path 8. The blow-by path 8 is provided with a check valve 36 that prevents fuel from flowing into the blow-by path 8 from the fuel supply path 5.

When the blow-by gas flows into the fuel supply path 5 via the blow-by path 8, the blow-by gas flows together with the fuel in the fuel supply path 5, and the blow-by gas is fed together with the fuel to the combustion chamber 21a of each of the cylinders 21 by the main fuel supply device 35. In this way, the blow-by gas is circulated through the blow-by path 8 and the fuel supply path 5, and the main fuel supply device 35 functions as a blow-by returning device 37 that returns the blow-by gas to the combustion chamber 21a, for example, a blow-by returning injector 37a.

As described above, the main fuel supply device 35 is controlled by the control unit 11 to intermittently inject fuel, and the main fuel supply device 35 functioning as the blow-by returning injector 37a also intermittently injects the blow-by gas supplied together with the fuel so as to return the blow-by gas to the combustion chamber 21a at the timing when the exhaust port 31 is closed and the intake port 29 is opened so that the blow-by of the fuel due to the valve overlap of the combustion chamber 21a does not occur.

The filter 9 is provided on the upstream side in the flow direction of the blow-by gas in the blow-by path 8. The filter 9 separates oil mist contained in the blow-by gas flowing through the blow-by path 8 to form an unburned air-fuel mixture, and is formed of, for example, a mist separator.

The externally driven pump 10 is provided downstream of the filter 9 in the blow-by gas flow direction in the blow-by path 8. The externally driven pump 10 is driven while the engine 2 rans (operates) (while fuel is supplied through the fuel supply path 5) to cause the blow-by gas to flow through the blow-by path 8 communicating with the crankcase 22, thereby sucking and/or pressurizing the blow-by gas to be merged the blow-by gas into the fuel supply path 5. The externally driven pump 10 causes the blow-by gas to flow in the blow-by path 8, thereby ventilating the inside of the crankcase 22 and setting the inside of the crankcase 22 to a negative pressure. Accordingly, the blow-by gas in the crankcase 22 is prevented from leaking from the crankcase 22 at a location other than the blow-by path 8, and for example, the blow-by gas is prevented from leaking from the crankcase 22 at a location where the crankshaft 27 is supported.

The externally driven pump 10 may be driven with the same strength to cause the blow-by gas to flow with the same strength regardless of whether or not the engine 2 is running (operating). Alternatively, the externally driven pump 10 may be driven at a relatively high intensity when the engine 2 is operating, and may be driven at a relatively low intensity when the engine 2 is stopped. Alternatively, the externally driven pump 10 may be driven until a predetermined time passes after the engine 2 is stopped, and the driving of the external drive pump 10 may be stopped after the predetermined time.

The control unit 11 is a computer such as an engine control unit (ECU) that controls operation of the engine 2, is provided with a CPU, a ROM, a RAM, and the like, and is configured to control each unit of the engine 2. The control unit 11 may store various programs for controlling the engine 2 and control the engine 2 by reading out a program and executing same.

In particular, the control unit 11 controls the injection timing of fuel by the main fuel supply device 35 and the injection timing of the blow-by gas by the blow-by returning injector 37a so that the blow-by of fuel due to the valve overlap of the combustion chamber 21a does not occur.

As described above, according to the present embodiment, the engine apparatus 1 runs on fuel containing a corrosive substance, and includes the blow-by returning injector 37a that returns the blow-by gas generated in the crankcase 22 of the engine 2 to the combustion chamber 21a of the engine 2. The corrosive substance contained in the fuel is ammonia or methanol.

Accordingly, the engine apparatus 1 is provided with the blow-by returning injector 37a for returning the blow-by gas containing a corrosive substance, so that the returning position of the blow-by gas can be set so as to suppress the flow of the blow-by gas in the intake system components such as the intake passage 3, the turbocharger 6, and the intercooler. Therefore, contamination of the intake system components by the blow-by gas can be suppressed to a minimum, to prolong the replacement interval of the intake system components. Since the intake system components can be formed by omitting a corrosion-resistant member or a corrosion-resistant coating for the blow-by gas, it is possible to suppress an increase in the cost of the intake system components and to suppress a decrease in the commercial value of the intake system components.

According to the present embodiment, the engine apparatus 1 includes the fuel supply path 5 for supplying fuel to the engine 2 and the blow-by path 8 connected from the crankcase 22 to the fuel supply path 5, and causes the blow-by gas to flow to the blow-by returning injector 37a via the blow-by path 8 and the fuel supply path 5.

Specifically, according to the present embodiment, the engine apparatus 1 includes the main fuel supply device 35 that supplies fuel supplied via the fuel supply path 5 to the combustion chamber 21a. The main fuel supply device 35 functions as a blow-by returning injector 37a that returns the blow-by gas supplied together with fuel via the fuel supply path 5 to the combustion chamber 21a.

Accordingly, the engine apparatus 1 returns the blow-by gas not to the intake passage 3 but to the fuel supply path 5, thereby making it possible to suppress contamination of the intake passage 3 by the blow-by gas. Since the fuel supply path 5 is originally based on the premise that fuel containing corrosive substance is circulated, it is not necessary to take a new contamination countermeasure against the returning of the blow-by gas containing corrosive substance.

According to the present embodiment, the engine apparatus 1 includes the externally driven pump 10 that causes the blow-by gas to flow in the blow-by path 8, and the blow-by gas is sucked and/or pressurized by the externally driven pump 10 to be merged into the fuel supply path 5.

Accordingly, the engine apparatus 1 can ventilate the inside of the crankcase 22 and make the inside of the crankcase 22 negative pressure by the externally driven pump 10. Therefore, the blow-by gas in the crankcase 22 can be prevented from leaking from the crankcase 22 at a location other than the blow-by path 8.

The engine apparatus 1 of the above-described embodiment describes an example in which the fuel supply path 5 includes the plurality of branched fuel paths 5a to supply fuel to each of the cylinders 21, and the plurality of main fuel supply devices 35 includes the gas admission valve, the gas injector, and the like are provided in each of the branched fuel paths 5a. However, the present invention is not limited to this example.

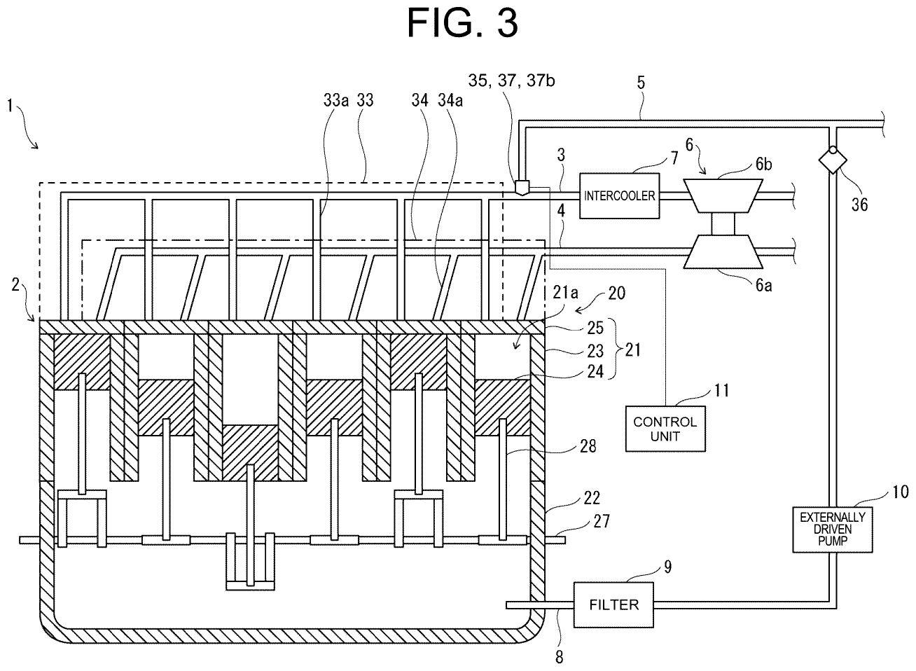

For example, in a first modification, as illustrated in FIG. 3, in the engine apparatus 1, the fuel supply path 5 may be formed without branching into a plurality of the branched fuel paths 5a, and the single main fuel supply device 35 formed by a gas mixing device such as a venturi mixer or a single point injector may be provided at the end of the fuel supply path 5 and connected to the intake manifold 33 before branching into the branched intake flow paths 33a or the intake passage 3 immediately before the intake manifold 33. The main fuel supply device 35 mixes fuel with air flowing through the intake passage 3 and the intake manifold 33.

In the first modification, the main fuel supply device 35 functions as a blow-by returning device 37 that returns the blow-by gas to the combustion chamber 21a, for example, a blow-by returning mixer 37b, and mixes the blow-by gas together with fuel with the air circulated in the intake passage 3 and the intake manifold 33.

The engine apparatus 1 of the above-described embodiment describes an example in which the blow-by path 8 is connected to the fuel supply path 5 to merged the blow-by gas with the fuel, and the main fuel supply device 35 that supplies the fuel supplied via the fuel supply path 5 to the combustion chamber 21a of each of the cylinders 21 functions as the blow-by returning device 37, such as the blow-by returning injector 21a or the blow-by returning mixer 37b, that returns the blow-by gas to the combustion chamber 37b. However, the present invention is not limited to this example.

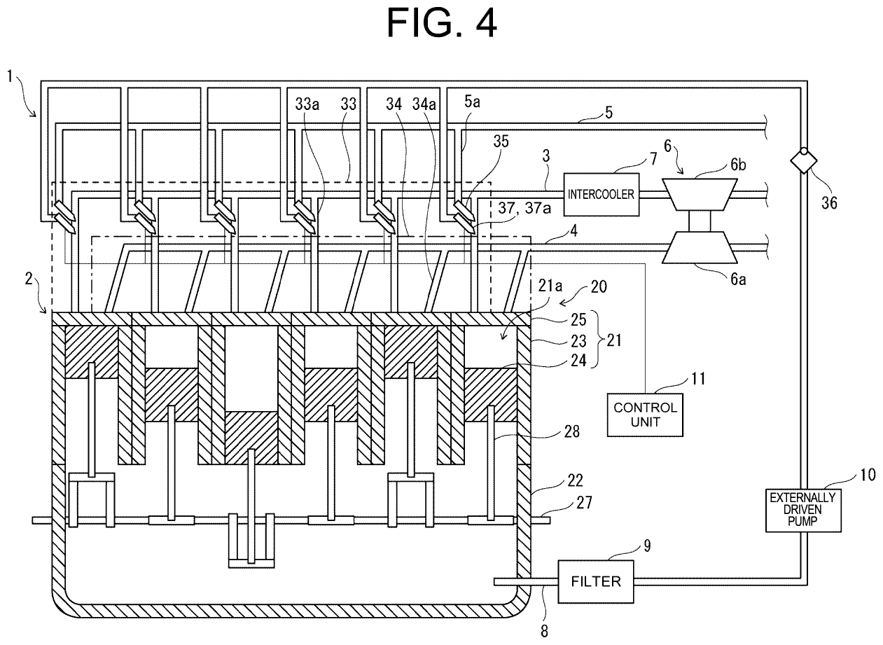

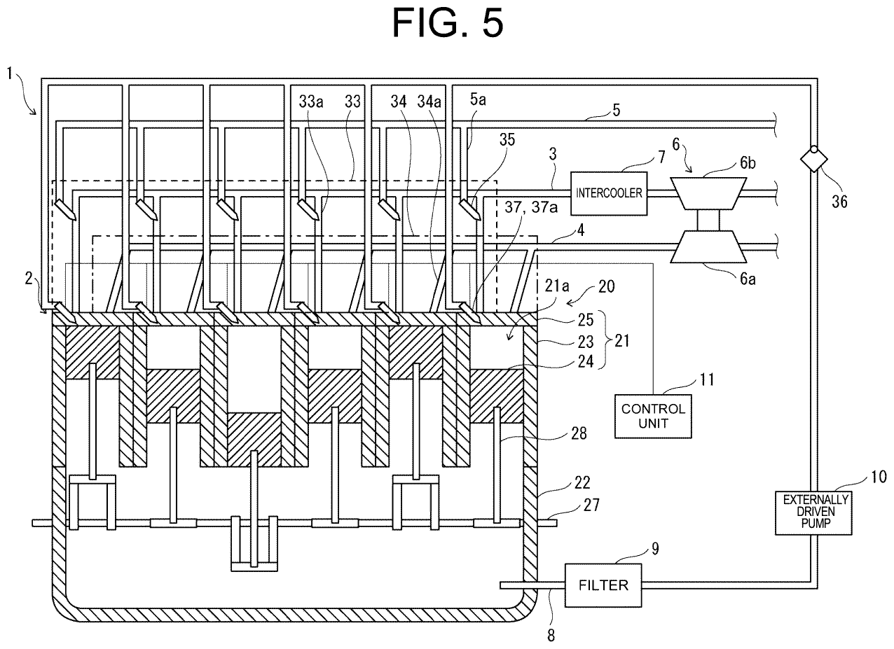

For example, in the second and third modifications, as illustrated in FIGS. 4 and 5, the engine apparatus 1 may be formed such that the blow-by path 8 is not connected to the fuel supply path 5 and the blow-by gas is merged with the air-fuel mixture, and the blow-by returning device 37, such as the blow-by returning injector 37a, independent of the main fuel supply device 35 may be provided at the terminal end of the blow-by path 8. That is, the blow-by path 8 allows the blow-by gas to directly flow to the blow-by returning injector 37a. For example, the blow-by path 8 branches into a plurality of branched blow-by paths 8a corresponding to the cylinders 21, and the blow-by returning injectors 37a independent of the main fuel supply device 35 are provided at respective terminal ends of the branched blow-by paths 8a.

In the second and third modifications, similarly to the above-described embodiment, the blow-by returning injector 37a intermittently injects the blow-by gas so as to return the blow-by gas to the combustion chamber 21a at the timing when the exhaust port 31 is closed and the intake port 29 is opened so that the blow-by of the fuel due to the valve overlap of the combustion chamber 21a does not occur.

In the second modification, as illustrated in FIG. 4, the branched blow-by paths 8a of the blow-by path 8 are connected to the branched intake flow paths 33a of the intake manifolds 33 of each of the cylinders 21, and the branched blow-by paths 8a provided in the blow-by returning injectors 37a return the blow-by gas to the respective combustion chambers 21a by injecting the blow-by gas at the terminal ends of the branched intake flow paths 33a of the intake manifolds 33 of each of the cylinders 21. In this case, the blow-by returning injectors 37a may be provided in the branched intake flow paths 33a on the downstream side of the main fuel supply device 35 in the intake direction.

In the third modification, as illustrated in FIG. 5, the branched blow-by paths 8a of the blow-by path 8 are connected to the cylinder heads 25 of the cylinders 21, and the blow-by returning injectors 37a provided in the branched blow-by paths 8a return the blow-by gas to the corresponding combustion chambers 21a by injecting the blow-by gas by the cylinder heads 25 of the cylinders 21.

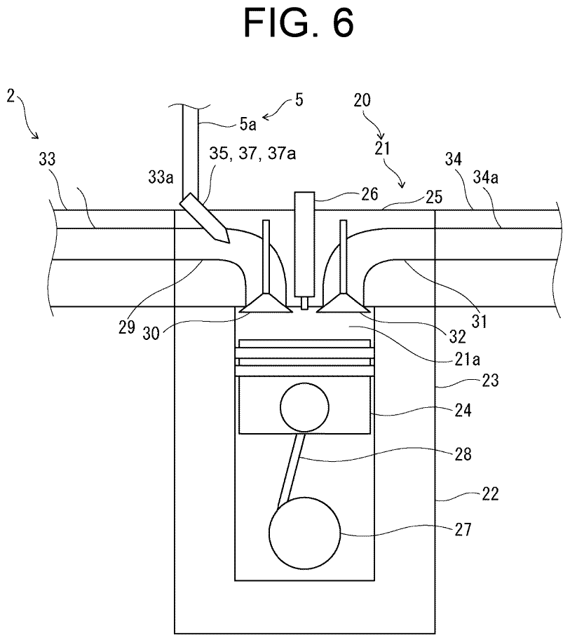

In this case, as illustrated in FIG. 6, each blow-by returning injector 37a is provided in the corresponding cylinder head 25 in a state of communicating with the combustion chamber 21a so as to directly inject blow-by gas to the combustion chamber 21a. The main fuel supply device 35, such as a gas admission valve or a gas injector, may alternatively be provided in the cylinder head 25 in a state of communicating with the combustion chamber 21a so as to directly inject fuel into the combustion chamber 21a.

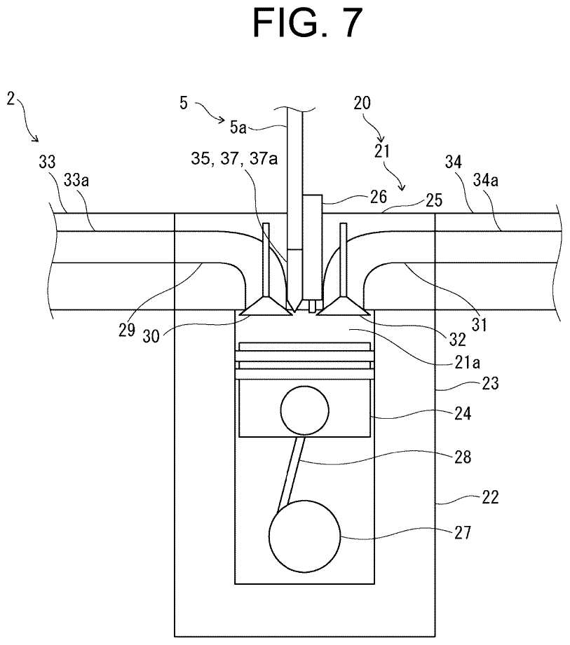

Alternatively, as illustrated in FIG. 7, the blow-by returning injector 37a is provided in the cylinder head 25 in a state of communicating with the intake port 29 so as to inject the blow-by gas into the intake port 29 communicating with the combustion chamber 21a. The main fuel supply device 35, such as a gas admission valve or a gas injector, may alternatively be provided in the cylinder head 25 in a state of communicating with the intake port 29 so as to inject fuel into the intake port 29.

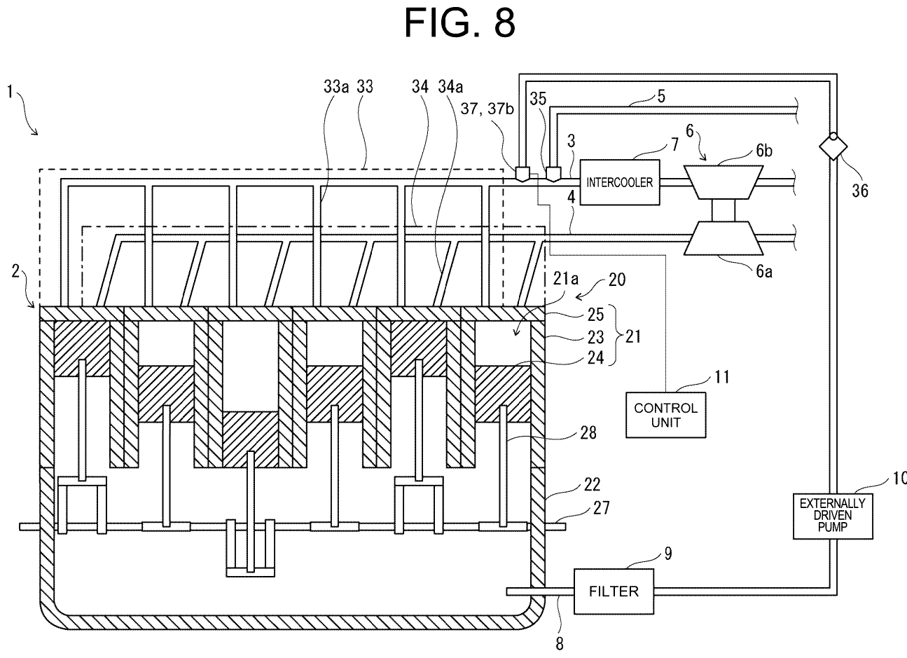

Alternatively, in the engine apparatus 1 of a fourth modification, as illustrated in FIG. 8, the blow-by path 8 is connected to the intake manifold 33 before branching to the branched intake flow paths 33a or to the intake passage 3 immediately before the intake manifold 33, and the single blow-by returning device 37 including a gas mixing device, such as a venturi mixer or a single point injector, independent of the main fuel supply device 35, for example, a blow-by returning mixer 37b, may be provided at the terminal end of the blow-by path 8. That is, the blow-by path 8 allows the blow-by gas to directly flow to the blow-by returning mixer 37b. In this case, the main fuel supply device 35 includes a gas mixing device, such as a venturi mixer or a single point injector, and the blow-by returning mixer 37b is preferably provided on the downstream side of the main fuel supply device 35 in the intake direction. The blow-by returning mixer 37b mixes the blow-by gas with the air flowing through the intake passage 3 and the intake manifold 33.

In the second, third, and fourth modifications, as in the above-described embodiment, the externally driven pump 10 causes the blow-by gas to flow in the blow-by path 8 communicating with the crankcase 22 to suck and/or pressurize the blow-by gas, thereby supplying the blow-by gas to the blow-by returning device 37, such as the blow-by returning injector 37a or the blow-by returning mixer 37b, via the blow-by path 8.

As described above, according to the second, third, or the fourth modification, the engine apparatus 1 includes the blow-by path 8 that is connected from the crankcase 22 to the blow-by returning device 37, such as the blow-by returning injector 37a or the blow-by returning mixer 37b, and causes the blow-by gas to flow to the blow-by returning device 37, such as the blow-by returning injector 37a or the blow-by returning mixer 37b.

Accordingly, since the engine apparatus 1 includes the dedicated blow-by path 8 through which the blow-by gas flows, in this way, it is possible to suppress the flow of the blow-by gas in the intake system components, such as the intake passage 3, the turbocharger 6, and the intercooler. Therefore, it is possible to minimize the contamination of the intake system components by the blow-by gas, and to prolong the replacement interval of the intake system components.

According to the second, third, or fourth modification, the engine apparatus 1 includes the fuel supply path 5 that supplies fuel to the engine 2, the main fuel supply device 35 that supplies fuel supplied via the fuel supply path 5 to the combustion chambers 21a, and the externally driven pump 10 that causes the blow-by gas to flow in the blow-by path 8. The blow-by returning device 37, such as the blow-by returning injector 37a or the blow-by returning mixer 37b, is provided independently of the main fuel supply device 35, and the blow-by gas is sucked and/or pressurized by the externally driven pump 10 and is supplied to the blow-by returning device 37, such as the blow-by returning injector 37a or the blow-by returning mixer 37b.

Specifically, in the engine apparatus 1 according to the second or third modification, the blow-by returning injector 37a returns the blow-by gas to the combustion chamber 21a by directly injecting the blow-by gas to the combustion chamber 21a, injecting the blow-by gas to the intake port 29 communicating with the combustion chamber 21a, or injecting the blow-by gas to the terminal end of the intake manifold 33 connected to the combustion chamber 21a.

Accordingly, since the engine apparatus 1 includes the dedicated blow-by path 8 through which the blow-by gas flows, it is possible to suppress the flow of the blow-by gas not only in the intake system components but also in the fuel supply path 5 and the main fuel supply device 35. Therefore, contamination of the fuel supply path 5 and the main fuel supply device 35 by the blow-by gas can be suppressed to a minimum, to prolong the replacement interval of the fuel supply path 5 and the main fuel supply device 35.

In the engine apparatus 1 according to the second or third modification, the blow-by returning injector 37a intermittently injects the blow-by gas.

Accordingly, in the engine apparatus 1, it is possible to suppress the fuel components of the blow-by gas from blowing through from the intake port 29 to the exhaust port 31 and flowing out to the exhaust side without being combusted at the time of valve overlap of the combustion chamber 21a. Therefore, the mixing of the blow-by gas with the exhaust gas can be suppressed, the deterioration of exhaust gas properties caused by the blow-by gas can be suppressed, and the effect of returning fuel consumption can be improved.

Note that the present invention can be properly modified within a range which does not contradict to a gist or a concept of the present invention that can be read throughout the claims and the specification, and an engine apparatus involving such modifications is also included in the technical concept of the present invention.

### Supplementary Notes of Invention

A summary of the present invention extracted from the above-described embodiments will be described below as supplementary notes. Each configuration and each processing function described in the following supplementary notes may be selected, omitted, and combined as appropriate.

### Supplementary Note 1

An engine apparatus that is ran on fuel including a corrosive substance, the apparatus comprising:
a blow-by returning injector or a blow-by returning mixer that returns blow-by gas to a combustion chamber of the engine.

### Supplementary Note 2

The engine apparatus according to Supplementary Note 1 further comprising:
a fuel supply path that supplies the fuel to the engine; and
a blow-by path connected to the fuel supply path,
wherein the blow-by gas is allowed to flow to the blow-by returning injector or the blow-by returning mixer through the blow-by path and the fuel supply path.

### Supplementary Note 3

The engine apparatus according to Supplementary Note 2, further comprising:
a main fuel supply device that supplies the fuel supplied via the fuel supply path to the combustion chamber,
wherein the main fuel supply device functions as the blow-by returning injector or the blow-by returning mixer that returns the blow-by gas supplied together with the fuel through the fuel supply path to the combustion chamber.

### Supplementary Note 4

The engine apparatus according to Supplementary Note 3, further comprising an external drive pump that allows the blow-by gas to flow in the blow-by path,
wherein the blow-by gas is sucked, pressurized, or both sucked and pressurized by the external drive pump to merge the blow-by gas into the fuel supply path.

### Supplementary Note 5

The engine apparatus according to Supplementary Note 1, further comprising:
a blow-by path that is connected to the blow-by returning injector or the blow-by returning mixer and allows the blow-by gas to flow to the blow-by returning injector or the blow-by returning mixer.

### Supplementary Note 6

The engine apparatus according to Supplementary Note 5, further comprising:
a fuel supply path that supplies the fuel to the engine;
a main fuel supply device that supplies the fuel supplied through the fuel supply path to the combustion chamber; and
an external drive pump that allows the blow-by gas to flow in the blow-by path,
wherein the blow-by returning injector or the blow-by returning mixer is provided independently of the main fuel supply device, and
the blow-by gas is sucked, pressurized, or both sucked and pressurized by the external drive pump and supplied to the blow-by returning injector or the blow-by returning mixer.

### Supplementary Note 7

The engine apparatus according to Supplementary Note 6, wherein the blow-by returning injector injects the blow-by gas directly into the combustion chamber, injects the blow-by gas into an intake port communicating with the combustion chamber, or injects the blow-by gas into a terminal end of an intake manifold connected to the combustion chamber.

### Supplementary Note 8

The engine apparatus according to any one of Supplementary Notes 1 to 7, wherein the blow-by returning injector intermittently injects the blow-by gas.

### Supplementary Note 9

The engine apparatus according to any one of Supplementary Notes 1 to 8, wherein the corrosive substance is ammonia or methanol.

### REFERENCE SIGNS LIST

1 engine apparatus
2 engine
3 intake passage
4 exhaust passage
5 fuel supply path
6 turbocharger
7 intercooler
8 blow-by path
9 filter
10 external drive pump
11 control unit
20 cylinder block
21 cylinder
21a combustion chamber
22 crankcase
23 cylinder portion
24 piston
25 cylinder head
26 ignition device
27 crankshaft
28 connecting rod
29 intake port
30 intake valve
31 exhaust port
32 exhaust valve
33 intake manifold
34 exhaust manifold
35 main fuel supply device
36 check valve
37 blow-by returning device
37a blow-by returning injector
37b blow-by returning mixer

1. An engine apparatus that operates with a fuel including a corrosive substance, the engine apparatus comprising:
a blow-by returning injector or a blow-by returning mixer that returns blow-by gas to a combustion chamber of the engine apparatus.

2. The engine apparatus according to claim 1, further comprising:
a fuel supply path that supplies the fuel to the engine; and
a blow-by path connected to the fuel supply path,
wherein the blow-by gas is allowed to flow to the blow-by returning injector or the blow-by returning mixer through the blow-by path and the fuel supply path.

3. The engine apparatus according to claim 2, further comprising:
a main fuel supply device that supplies the fuel supplied via the fuel supply path to the combustion chamber,
wherein the main fuel supply device functions as the blow-by returning injector or the blow-by returning mixer that returns the blow-by gas supplied together with the fuel through the fuel supply path to the combustion chamber.

4. The engine apparatus according to claim 3, further comprising an external drive pump that allows the blow-by gas to flow in the blow-by path,
wherein the blow-by gas is sucked, pressurized, or both sucked and pressurized by the external drive pump to merge the blow-by gas into the fuel supply path.

5. The engine apparatus according to claim 1, further comprising:
a blow-by path that is connected to the blow-by returning injector or the blow-by returning mixer and allows the blow-by gas to flow to the blow-by returning injector or the blow-by returning mixer.

6. The engine apparatus according to claim 5, further comprising:
a fuel supply path that supplies the fuel to the engine;
a main fuel supply device that supplies the fuel supplied through the fuel supply path to the combustion chamber; and
an external drive pump that allows the blow-by gas to flow in the blow-by path,
wherein the blow-by returning injector or the blow-by returning mixer is provided independently of the main fuel supply device, and
the blow-by gas is sucked, pressurized, or both sucked and pressurized by the external drive pump and supplied to the blow-by returning injector or the blow-by returning mixer.

7. The engine apparatus according to claim 6, wherein the blow-by returning injector injects the blow-by gas directly into the combustion chamber, injects the blow-by gas into an intake port communicating with the combustion chamber, or injects the blow-by gas into a terminal end of an intake manifold connected to the combustion chamber.

8. The engine apparatus according to claim 7, wherein the blow-by returning injector intermittently injects the blow-by gas.

9. The engine apparatus according to claim 1, wherein the corrosive substance is ammonia or methanol.
